(19) United States
(12) Patent Application Publication
(10) Pub. No.: US 2008/0147711 A1
(43) Pub. Date: Jun. 19, 2008

(54) METHOD AND SYSTEM FOR PROVIDING PLAYLIST RECOMMENDATIONS

(75) Inventors: Michael Spiegelman, LOS ANGELES, CA (US); Todd Beaupre, LOS ANGELES, CA (US); Christopher Staszak, SAN DIEGO, CA (US); Daniel Baird, Carlsbad, CA (US); Bradley DeKindig, San Diego, CA (US); Christa Stelzmuller, Long Beach, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: YAHOO! INC., SUNNYVALE, CA (US)

(21) Appl. No.: 11/612,884

(22) Filed: Dec. 19, 2006

(51) Int. Cl. G06F 17/30; G06F 7/06

(52) U.S. Cl. 707/102; 707/3; 707/E17.005

(57) ABSTRACT

Methods and systems for recommending playlists to a user are disclosed herein. A set of artist names corresponding to artists that the user has indicated a preference for is identified. A playlist repository that stores media playlists is accessed. The media playlists can include artist information. The playlist repository is searched to identify a playlist having playlist artist information that is relevant to the user-identified set of artist names. The identity of the identified playlist is communicated to the user.

### BACKGROUND

1. Field

This disclosure relates to methods and systems for recommending media playlists to users.

2. General Background

The expansion of the Internet and the World Wide Web (“web”) has given computer users the enhanced ability to listen to and to watch various different forms of media through their computers. This media can be in the form of audio music, music videos, television programs, sporting events or any other form of audio or video media that a user wishes to watch or listen to. As time evolved, users were able to take the music that was on that compact disc store it on their computers and listen to it locally. Recently web systems have allowed users log on to a network such as the Internet and, using a media player, either listen to specific media chosen from a group of media that a particular service has to offer, or to listen to an array of media offerings such as a radio station. Different songs or other forms of media are combined to allow a user to listen to a group of songs in sequence, whether chosen by the user or by the operators of the network service. For example, such a service is Yahoo! Music. Many media players, services and other software tools enable media to be organized by a user or a service into playlists, which, as the name connotes, are groups or lists of media files or file identifiers that can be used to effect playback by a user in a sequence or other selected or random order. Further, once a playlist is created, a user may manipulate and edit the playlists freely.

### SUMMARY

Methods and systems for recommending playlists to a user are disclosed herein. A set of artist names corresponding to artists that the user has indicated a preference for is identified. In one aspect, the preference indication can be derived from a playlist created by the user. In another aspect, the preference indication can be derived from a user profile. In yet another aspect, the indication of preference of an artist can be received by receiving a rating of the artists based on a predefined scale. In another aspect, the preference indication can be derived from any communication from the user indicative of a preference. A playlist repository that stores media playlists can be accessed. The media playlists can include artist information. The playlist repository is searched to identify a playlist having playlist artist information that is relevant to the user-identified set of artist names. The identity of the identified playlist is communicated to the user. The playlist comprises a playlist of video clips or songs.

In one aspect of the method, a selection of the playlist can also be received from the user. A bookmark that references the playlist can be stored for later access by the user. Alternatively, or in addition thereto, a copy of the playlist can be copied for later access by the user. Furthermore, the user can be permitted to edit the copy of the playlist.

In another aspect of the method, the identity of at least one popular playlist can be communicated to the user. In addition, the identity of at least one celebrity selected playlist to the user can be communicated to the user.

The set of artist names can correspond to representative artists of a playlist created by the user. Alternatively, or in addition thereto, the set of artists names are obtained from a user profile stored in a user profile database.

The artist information can correspond to artists that are representative of the artists in the playlist. The artist information can be, for example, indicative of representative artists of the playlist.

In another aspect, a system generated playlist can be stored in the playlist repository. In yet another aspect, a user created playlist can be stored in the playlist repository. The playlist repository can comprise a public playlist database containing data related to published playlists.

In another aspect of the method, a representative artist of the playlist can be an artist that is associated with at least two songs in the playlist. Additionally, a representative artist of the playlist can be an artist that is associated with at least three songs in the playlist.

In another aspect of the method, artist information can be deemed relevant to the set of artist names if all of the names of the set of artist names match the artist information of the playlist. In another aspect, artist information can be deemed relevant to the set of artist names if some of the names of the set of artist names match the artist information of the playlist.

In one aspect, there is a system for recommending playlists to a user, comprising a playlist repository and a recommendation module. The playlist repository can store media playlists which include artist information. The recommendation module can search the playlist repository to identify a playlist having artist information that is relevant to a set of artist names. The set of artist names can be indicative of the artists for which the user has indicated a preference. The recommendation module can be further configured to communicate the identity of the identified playlist to the user.

In another aspect, there is a method of recommending playlists to a user. Media preferences corresponding to characteristics of media that a user has indicated a preference for are identified. A playlist repository that stores media playlists can then be accessed. At least one playlist in the playlist repository comprises associated media information. The playlist storage is searched to identify a playlist with information relevant to media preferences of the user. The identity of the relevant playlist is communicated to the user.

In yet another aspect, there is a user interface for recommending playlists. The user interface can comprise a playlist display pane and a bookmark area. The playlist display pane includes at least one thumbnail representing a playlist. The at least one thumbnail includes one or more images representative of playlist information. At least one thumbnail can be dragged onto the bookmark area. Upon the at least one thumbnail being dragged onto the bookmark area, the playlist being represented by the at least one thumbnail can be deemed selected by the user.

### DRAWINGS

The features and objects of alternate embodiments of the present disclosure will become more apparent with reference to the following description taken in conjunction with the accompanying drawings of various examples wherein like reference numerals denote like elements and in which:

FIG. 1 depicts a system for recommending playlists according to one embodiment.

FIG. 2 depicts a component diagram of a data processing system according to one embodiment.

FIG. 3 depicts a flow diagram of a process for creating playlists according to one embodiment.

FIG. 4 depicts an exemplary data structure of a playlist according to one embodiment.

FIG. 5 depicts a flow diagram of a process for marking playlists as public according to one embodiment.

FIG. 6 depicts a screenshot of a user interface for creating playlists according to one embodiment.

FIG. 7 depicts a screenshot of a user interface for editing a user profile according to one embodiment.

FIG. 8 depicts a flow diagram of a process of recommending a playlist according to one embodiment.

FIG. 9 depicts a flow diagram of another exemplary process of recommending a playlist according to one embodiment.

FIGS. 10-12 depict a screenshot of a user interface for recommending playlists according to one embodiment.

### DETAILED DESCRIPTION

A system and method of recommending media playlists to a user is described herein. Playlists recommended to users are derived from a pre-existing set of playlists. The pre-existing set of playlists can be created utilizing user-created playlists, system-created playlists, or a combination thereof. For instance, a user-created playlist that is designated by the playlist creator to be a public playlist can be recommended other users who have similar music taste. As disclosed herein, a playlist creator is a user who has created a playlist, and a playlist recommendee is a user to whom playlists are recommended.

In one embodiment, playlists can be associated with representative media information of the playlist. Representative information of the playlist can include, for instance, representative artists of the playlist. In another example, representative information of the playlist can include genres of the playlist. Depending upon user preferences stored in user profiles, playlists with representative information relevant to the user preferences can be identified and recommended to the user.

As discussed herein, playlists refer to a combination of media elements to be played in some order. Media elements can be songs, video clips, or any other multimedia combination.

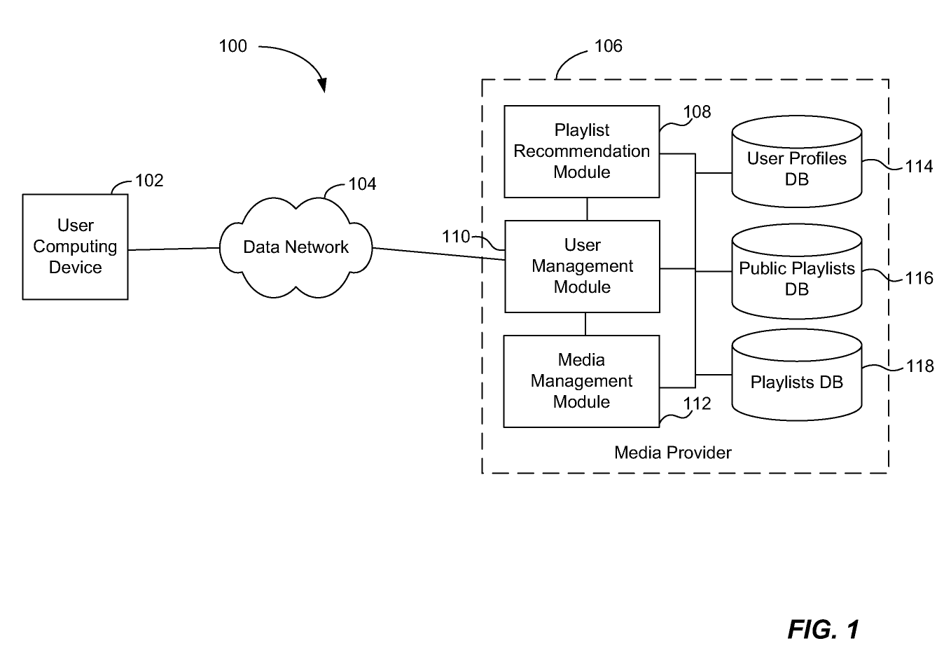

FIG. 1 illustrates a system 100 for creating and recommending playlists. The system 100 can comprise a user computing device 102 which communicates with a media provider 106 through data network 104. The media provider can be, for example, an online music provider that distributes media content over the data network 104. In one example, the data network 104 can be the Internet. In another example, the data network 104 can be an intranet. In yet another example, the data network 104 can be a WAN or LAN network.

Users can communicate with the media provider 106 utilizing the user computing device 102. In one embodiment, the user computing device 102 includes a processor that permits loading and executing computer programs to render media files. The user computing device 102 can be, by way of non-limiting example, a personal computer, a cellular telephone, a personal data assistant, a portable media player or any other computing device capable of receiving, interpreting and rendering media files. In addition, the user computing device 102 can be configured with a memory module that stores one or more software components such as a messaging program, a digital rights management component, media files, plug-in applications, media databases, etc.

A user management module 110 can be configured with a web server computer program that can render webpages communicated to the user computing device 102 through the data network 104. The user computing device 102 can then communicate the webpages using a web browser installed at the user computing device 102. Therefore, in one example, the user management module 110 can be a collection of software modules that include computer coding in HTML, XML, or in any other mark-up language that can be rendered at a web browser. In another example, the user management module can be a collection of software modules or processes that transmit and receive data with a computer application running at the user computing device 102.

The user management module 110 can be configured to receive instructions from a user at the user computing device 102 so as to permit the user to manage the user's profile, user preferences, etc. For example, a user can create a user account at the user management module 110 and manage song, video, and multimedia preferences.

Thus, the user management module 110 can further be configured to permit a user to set preferences such as media preferences and media playlist preferences. For example, a user can set preferred music genres or preferred music artists. In another example, the user may set preferences for ratings of one or more songs according to a predefined scale. In another example, a user may set preferred playlists. In addition, the user management module 110 can also be configured with logic to permit a user to search playlists of other users who have created playlists.

The user management module 110 can be configured to interact with a user profiles database 114, a public playlists database 116, and a playlists database 118. Each of these databases can be data repositories that are implemented utilizing mass storage devices such as optical discs, magnetic discs, or any other form or recordable and readable memory.

The user management module 110 can interact with the user profiles database 114 to store and access user profiles. In addition, the user management module 110 can also interact with the playlists database 118 in order to store playlists that a user has created. Thus, the playlists database 118 can include one or more playlist entries representative of playlists created by a user. In one example, a playlist entry can include the name of the playlist, the length of the playlist, representative artists of the playlist, representative genres of the playlist, representative albums of the playlist, and/or representative songs on the playlist. In a further example, the playlist entry can also include a list of songs in the playlist, a list of artists in the playlists, etc.

Furthermore, the user management module 110 can also be configured to interact with the public playlists database 116. The public playlists database 116 can include entries of playlists that a user has designated to be public. A designation of “public” can indicate that the playlist has been designated to be available for any user to access and copy. For example, public playlists can be communicated through the data network 104, to the user computing device 102 for displaying at the user computing device 102 such that users can copy the playlist, select the playlist, or render the playlist at the user computing device 102. A user who has created a playlist can indicate, through the user management module 110, that a certain playlist is private or public. If the user selects that the playlist be private, the playlist database 118 can mark the playlist with an indication or flag that the playlist is to be private, and not shared with other users. As such, if a user-created playlist is designated is being private, only the user who created the playlist can query the playlist database 118 for the playlists that are associated with the user, regardless of whether they are private or public. The playlists associated with the user can then be rendered at the user computing device 102, and other users cannot view or access such user-created playlist.

On the other hand, playlists that have been designated as public can be stored at the public playlists database 116. In one embodiment, the playlists stored in the public playlist database 116 are stored in the form of a link or reference or pointer to the playlists database 118. A media management module 112 can be configured to create the reference the playlist at playlists database 118. In this manner, the public playlist database 116 can be small memory size and easy to parse and search utilizing known search algorithms.

In one embodiment, the public playlist database 116 can include additional fields for each playlist. Thus, for example, each playlist can include a pointer to the data in the playlist database 118, and fields for representative artists' name and a description of the playlist. The representative artists' name, the description information, or any other data provided by the user who created the playlist in relation to a playlist can be useful to a recommendation engine or another user who is searching for playlists. In one example, the playlist description information can be utilized to recommend the playlist to one or more users. In yet another example, any data submitted by a playlist creator can be utilized to recommend the playlist to one or more users.

In another embodiment, the playlists that have been designated as public can be stored at the public playlists database 116 as a complete entry such that all the information of the playlist is included in the public playlists database 116 and does not need to be referenced to the playlists database 118. The media management module 112 can make a copy of the playlist and store the copy of the playlist in the public playlists database 116.

As such, whether stored as references to the playlists in the playlists database 118, or as a copy of the playlists in the playlists database 118, the playlists stored in the public playlist database 116 can be a subset of the playlists stored in the playlist database 118. As discussed above, the playlists stored in the public playlist database 116 can be marked to be public and accessible and searchable by one or more users.

The media management module 112 can further be configured with other logic to manage media related to the playlists in the playlists database 118. For example, the media management module 112 can identify the representative artists stored in a playlist in playlists database 118. The representative artists can be determined by selecting the artists having the highest number of songs or media elements in the playlist.

Additionally, the user management module 110 can be configured to interact with a media management module 112 to retrieve playlists that have been marked to be public. For example, once the user management module 110 receives an instruction for creation of a playlist, the playlist can be stored in the playlists database 118. The media management module 112 can assist the user management module 110 to create the playlist and, further, to flag the playlist as being public upon receipt from the first user an indication that the playlist is to be public. The user management module 110 can then interact through the data network 104 with a second user who has indicated a pre-specified media preference, such as by non-limiting example, a preference for an artist, song, album, etc. A playlist recommendation module 108 can be configured to access the second user profile to determine the type of music or the type of artists or any other preferences set by the second user. Depending upon the preferences set by the second user, the playlist recommendation module 108 can then identify playlists that are stored or indexed at the public playlists database 116 and recommend the playlists that match the media preferences of the second user.

As such, the playlist recommendation module 108 can identify a playlist created by first user and recommend such playlist to the second user. In one embodiment, the recommendation is provided to the second user when the second user requests a recommendation. In another embodiment, the recommendation is automatically provided to the second user upon the second user logging in to the account through the user management module 110.

As previously discussed, one or more users utilizing a user computing device can communicate through the data network 104 with the media provider 106 in order to select media, report media and download media through the data network 104. Therefore, the user computing device 102 can directly communicate with the user management module 110. In turn, the user management module 110 can communicate with a playlist recommendation module 108 and with the media management module 112 in order to provide the user with a full media experience, such as creating playlist, receiving playlist recommendation, downloading music, rendering recommended playlist, downloading playlist from friends, acquaintances or any other user of the media provider 106.

In another embodiment, public playlist database 116 further includes playlist that have been created by the media provider 106. Therefore, the public playlist database 116 could not include playlist that users have previously created, but can also include playlist that the media provider 106 has created for recommendation to users and searching by users. Playlist stored in the public playlist database 116 can also be accessed through a search engine provided by the media provider 106. Therefore, a user of the user computer device 102 can further search for playlists that the user may like depending on attributes of the playlists and any other searchable data.

Once the playlist recommendation module 108 determines the media preferences of the user, (e.g., artists preferred by the user), the recommendation engine can then utilize the user's media preferences to query the public playlist database 116 to determine most relevant playlists. The media preferences of the user can be determined by extracting user ratings of media characteristics according to a predefined rating scale.

By way of non-limiting example, a user's media preferences can include a set of favorite song artists that the user has rated highly. The playlist recommendation module 108 can then utilize the set of favorite artists of the user and make a determination of the most relevant playlists from the public playlist database 116. Thus, the playlist recommendation module 108 can correlate the artists determined to be the user's favorite, and compare the name of each artist in the set of favorite artists to each of the representative artist listing of each playlist and determine one or more relevant playlists.

The playlist recommendation module 108 can further be configured to filter the search results from the query to the public playlist database 116. In one embodiment, the filtering can occur by excluding long playlists. In another embodiment, the filtering can include removing short playlists. In another embodiment, the filtering can include removing a playlist from the search results that does not meet a pre-determined threshold of relevance preconfigured by a user. In yet another embodiment, filtering can comprise removing computer generated playlists. Various algorithms can be utilized to determine whether a playlist has been generated by a computer.

Once the relevant playlists are generated, the playlists can be ranked according to a particular order set by the recommendation module 108 or by the recommendee user. In one embodiment, the playlist recommendation module 108 selects a predefined number of highly relevant playlists ranked by order of relevance. For example, relevance can be determined utilizing a score system that assigns high scores to playlists that are relevant to the playlist recommendee, and lower scores if the playlists, although relevant, have a lower relevancy to the playlist recommendee. In one example, ten playlists can be determined to be relevant to the playlist recommendee. The playlist recommendation module 108 can then select the top five playlists and only recommend the selected top five playlists to the playlist recommendee.

In yet another embodiment, only a subset of the relevant playlists can be provided to the user. The subset can be determined according to user preferences, random generation, etc. In another embodiment, the entire list of relevant playlists can be provided to the user.

Playlist recommendation can be initiated in multiple ways. In one example, playlist recommendation can be initiated by a user if, for example, the user indicates that the user wants to receive recommendations of playlists. In another embodiment, the playlist recommendation module 108 can automatically initiate the recommendation for all users. In another embodiment, the playlist recommendation module 108 can automatically initiate a recommendation to a randomly assigned user.

Playlist recommendation can also be processed based on attributes or characteristics of existing playlists that have been created by the user receiving the recommendation (i.e. the playlist recommendee). In one embodiment, playlist recommendation can be based on affinity of playlists created by a user and playlists in the public playlists database. Thus, a user can be recommended a playlist that an affinity engine deems to be similar to a playlist that the user created. An affinity algorithm that matches characteristics of user playlists with characteristics of public playlists can be utilized to locate playlists that can be recommended to the user. Characteristics of playlists can include playlist descriptor information, songs, genres, representative artists, etc. For example, a user may have created a playlist with Rock as a predominant genre of the playlist. Based on the characteristics of the playlist, namely that the playlist is a predominantly Rock playlist, playlists having predominantly Rock songs can be searched in the public database. Results containing can then be provided to the user. In addition, the recommendation can be based on the number of playlists having a specific characteristic. For example, if the user has more than one playlist having primarily songs of Rock, there is a high likelihood that the user likes Rock, and will appreciate receiving recommendations of Rock playlists.

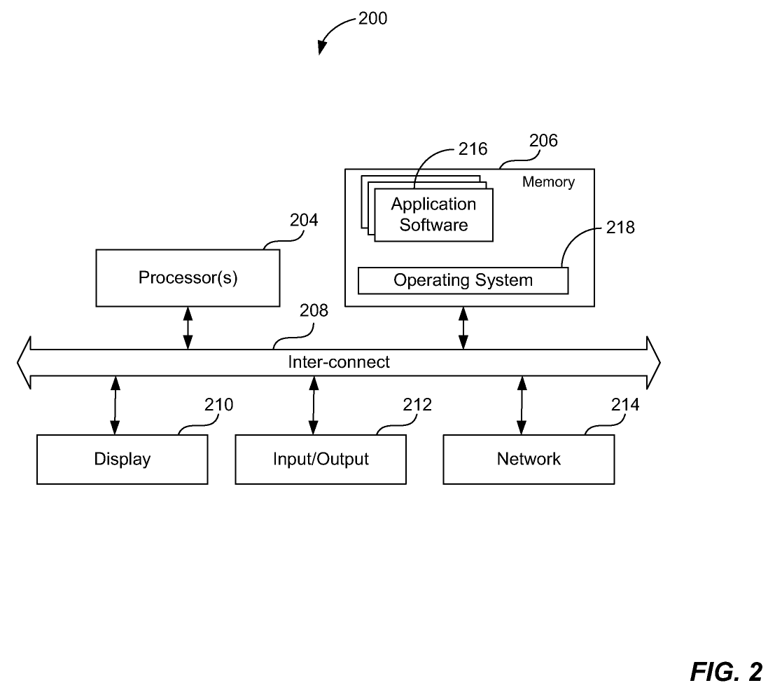

FIG. 2 depicts a component diagram of a data processing system 200. The data processing system 200 can be utilized to implement one or more computing devices, computer processes, or software modules described herein. In one example, the data processing system 200 can be utilized to process calculations, execute instructions, receive and transmit digital signals, as required by the user computing device 102. In one example, the data processing system 200 can be utilized to process calculations, execute instructions, receive and transmit digital signals, as required by the playlist recommendation module, the user management module or the media management module.

The system 200 includes an inter-connect 208 (e.g., bus and system core logic), which interconnects a microprocessor(s) 204 and memory 206. The interconnect 208 interconnects the microprocessor(s) 204 and the memory 206 together. Furthermore, the interconnect 208 interconnects the microprocessor 204 and the memory 206 to a display device 210 and to peripheral devices such as input/output (I/O) devices 212. Typical I/O devices include mice, keyboards, modems, network interfaces, printers, scanners, video cameras and other devices.

Furthermore, the interconnect 208 may include one or more buses connected to one another through various bridges, controllers and/or adapters. In one embodiment, I/O device 212 can include a USB (Universal Serial Bus) adapter for controlling USB peripherals, and/or an IEEE-1394 bus adapter for controlling IEEE-1394 peripherals. The inter-connect 208 can also include a network connection 214.

The memory 206 may include ROM (Read Only Memory), and volatile RAM (Random Access Memory) and non-volatile memory, such as hard drive, flash memory, etc. Volatile RAM is typically implemented as dynamic RAM (DRAM) which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory may also be a random access memory.

The memory 206 can be a local device coupled directly to the rest of the components in the data processing system. A non-volatile memory that is remote from the system, such as a network storage device coupled to the data processing system through a network interface such as a modem or Ethernet interface, can also be used. The instructions to control the arrangement of a filter structure may be stored in memory 206 or obtained through an I/O device 214.

In general, routines executed to implement one or more embodiments may be implemented as part of an operating system 218 or a specific application, component, program, object, module or sequence of instructions referred to as application software 216. The application software 216 typically can comprises one or more instructions sets that can be executed by the microprocessor 204 to perform operations necessary to execute elements involving the various aspects of the methods and systems as described herein.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

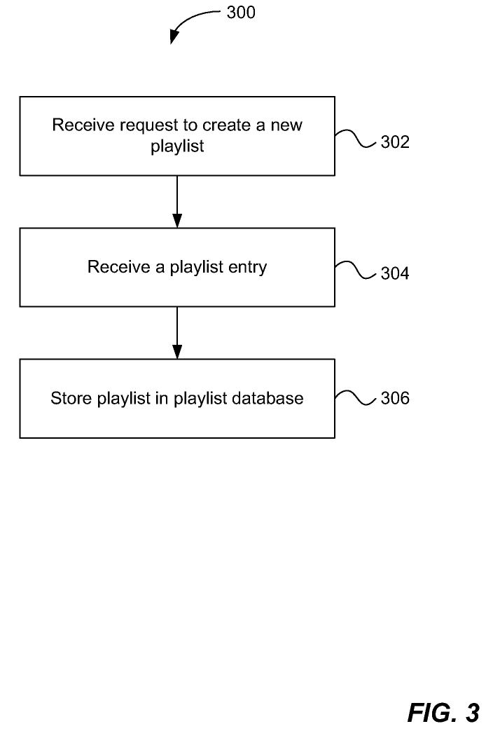

FIG. 3 depicts a flow diagram of a process 300 for creating playlists. At process block 302, a request to create a new playlist is received from the user. For exemplary purposes, the user that creates the playlist will be referred to as playlist creator. The playlist created by the user can be created in any number of different ways. For example, the playlist can be created based on the user selecting each piece of media, such as a song, video or any other media. In another embodiment, the playlist can be generated automatically by the media management module 112. In one example, the playlist creator's user profile stored at the user profile database 114 can be utilized to generate the playlist.

The playlist can comprise, at least, one media file or a media file identifier. For example, the media file identifier can comprise the file path of the media file at which the media file is located. Furthermore, upon creation of the playlist, the user can be provided with the opportunity to enter user-defined descriptor information related to the playlist. User-defined descriptor information permits the user to creatively enter free form text, prose, and tags with keywords that the user believes describe characteristics of the feelings or moods set by the user published playlist. For example, a user can identify a specific purpose, environment, mood or concept of a playlist, such that only the user would understand. User defined descriptor information can refer to any type of user provided text, tags with keywords, describing the users understanding, perception of feelings towards a playlist and the media contained therein. In contrast, other attributes of the playlist such as the title of the playlist artist, genres and songs included in the playlist, etc. can be factual and provide objective information that does not include the playlist creator's judgment on the quality, mood, feeling or any other subjective judgment of the playlist. The process 300 continues at process block 304.

At process block 304, a playlist entry is received from the playlist creator. The playlist entry can include a song that is added to the newly created playlist. The playlist in general includes one or more songs, videos, or any other multi-media element that can be grouped to create a playlist. Therefore, a playlist entry such as a music file can be utilized to create a playlist. As indicated above, not only playlist information such as playlist name, date of creation, etc. can be indicated by a user, but also associated metadata with media files within the playlist. Metadata related to each media file can include the media file name, the artist name, the album, the length of the media file, the date of the creation, rating, etc. Further elements associated to the playlist can also be included, such as identity of a creator, further information regarding the playlist, such as a URL, an image associated to the playlist, licensing terms, etc.

Thus, when a playlist is created the playlist information and user-defined descriptor information can be serialized into searchable format. In one example, the playlist recommendation module 108 can include logic to search through the searchable format fields of the playlist data and the metadata of the playlist, as well as data related to media files related to each playlist. In another example, users can then submit a search that can parse through all of the searchable fields to find information about the playlist and the contents of the playlist. The process 300 continues to process block 306.

At process block 306, the playlist is stored in the playlist database 118. In a further embodiment, if the user, upon creation of the playlist, indicates that the playlist is a public playlist, the playlist can be copied immediately and automatically to the public playlist database 116. In another embodiment, if a user indicates that the playlist is to be designated as a public playlist a pointer can be stored at the public playlist database 116. As such, the public playlist database 116 can be configured to store pointers that reference entries at the playlist database 118.

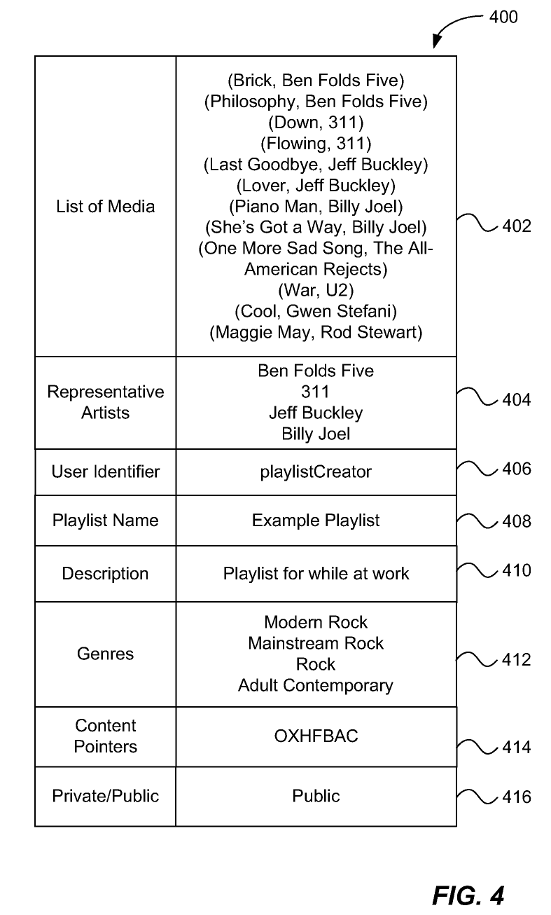

FIG. 4 depicts an exemplary data structure of a playlist. The data structure 400 can be a vector, and array, a record, a class object, an entry, or any other data structure known in the art. The data structure 400 depicts an example only of how the data related to a playlist can be stored. However, variations of the fields of the data structure, the number of fields of the data structure, the contents of the fields of the data structure, and the metadata stored therein are variations that are contemplated in one or more embodiments of this disclosure. A field 402 of data structure 400 can include a list of songs and artists that comprise a playlist corresponding to data structure 400. The field 402 includes song title and artist pairings that indicate the name of the song and the artist corresponding to the song. In one example, two songs can have the same title but different artists. In another example, two songs can have different titles but the same artist. For example, the first two songs in field 402 are “Brick” and “Philosophy.” Both songs correspond to the artist Ben Folds Five. In another embodiment, field 402 can simply include a list of artists in the playlist. In another embodiment, field 402 can include a list of song titles in the playlist.

A field 404 can include a list of representative artists of the playlist. Field 404 can be configured to include any number of representative artists of a playlist. For example, field 404 can be configured to include three representative artists of a playlist. In another example, field 404 can be configured to include two representative artists of a playlist. Field 404, as shown in FIG. 4, includes the artists Ben Folds Five, 311, Jeff Buckley, and Billy Joel. The representative artists included in fields 404 can correspond to artists of songs that have the highest number of songs in the playlist. As it can be seen from field 402, the first two songs, namely, “Brick” and “Philosophy,” are related to artist Ben Folds Five. The next two songs, “Down” and “Flowing” are related to artist 311. Likewise, the next two songs, namely, “Last Goodbye” and “Lover,” are related to artist Jeff Buckley. The next two songs in the playlist, “Piano Man” and “She's Gone Away,” are related to artist Billy Joel. The next four consecutive songs of the playlist are each related to a different artist. Therefore, the artists Ben Folds Five, 311, Jeff Buckley and Billy Joel have at least two songs in the playlist. Because each of these artists has a higher number of songs in the playlist, they can be deemed to be the representative artists of a playlist. In another example, if each of the songs has a different artist such that each artist has the same number of songs in the playlist, the representative artists in field 404 can be the first four artists in the playlist; namely, the artists corresponding to the first four songs in the playlist. In yet another example, if the last four songs in field 402 were all songs related to artist U2, artist U2 would be in the representative artist group listed in field 404. Furthermore, artist U2 would be listed first, since the number of songs would be the highest number of songs by a representative artist.

A playlist creator field 406 for the user name of the creator of a playlist can also be included as part of the data structure 400. In one embodiment, a playlist can be related to the user who created the playlist. The playlist creator field 406 can include a user identifier that corresponds uniquely to each playlist creator that interacts with a user management module 110. In one embodiment, the playlist creator field 406 is utilized to access the user identifier to invoke the playlists that a user has stored. For example, upon a user logging in the system and requesting private playlists from the user management module 110, the user management module 110 can access the playlists from playlist database 118 using a query that includes the user name or user identifier and queries all the playlists having that user identifier stored in the playlist creator field 406. In addition, the user identifier stored in the playlist creator field 406 can further be utilized by the playlist recommendation module 108 when recommending playlists to a playlist recommendee. In other examples, the playlist creator field 406 can be queried by the playlist recommendation module 108 to determine playlists that have been created by playlist creators having similar profiles as the playlist recommendee.

In a further example, the playlist creator field 406 can be utilized by a media management module 112 in connection with functionalities of the user management module 110 in order to provide playlists that have been created by a specific user contact, messaging contact, celebrity, friend, family member, or any other acquaintance of a user. Therefore, a user that is searching for playlists can query the playlist database 118 for playlists that correspond to a specific contact of a user. For example, a user can query the playlists that a friend has made public. The query is executed by searching for the user identifier of the friend of the user at the public playlists database 116.

Field 408 corresponds to a playlist name that includes the name of the playlist as created by the playlist creator. For example, the playlist name in user-created playlist 400 is Example Playlist. Furthermore, a field 410 can be included as part of the data structure 400.

Field 410 can correspond to the description of a playlist. In the data structure 400, the value for the description of field 410 is playlist for “Rock music for working out.” Other descriptions can be inserted as a user creates a playlist or as a user edits a playlist. Therefore, the user management module 110 and the media management module 112 can be genres configured to provide the functionality of allowing a user to enter or edit a description of the playlist. Furthermore, a field 412 can include the genres that correspond to the playlist. In one example, the genres in fields 412 can be representative genres of the music in the playlist.

In addition, a field 414 can also be included as part of the data structure 400. The field 414 can correspond to content pointers that reference the source of the media files associated with the playlist illustrated in data structure 400. For example, the content pointer can include a register address in hexadecimal system. In another example, the content pointer can simply be the file path of the media file associated with the playlist.

In addition, a field 416 can also be included in data structure 400 for denominating whether the playlist is private or public. For example, the field 416 can store a flag that is set to 1 if the playlist is public and set to 0 if the playlist is not public. As illustrated in data structure 400, the playlist of this example has been designated as “public.” In one embodiment playlists can the designated by default to be private and only be accessible to the creator of the playlist. Then, the creator of the playlist makes the playlist public. The playlist can then be accessible by any other users who search playlists or by the playlist recommendation module 108 that searches public playlists. In another embodiment, upon the creation of a playlist, the user is required to input a designation of public or private and no assumption is made as to whether a playlist is public or private unless a playlist creator indicates so.

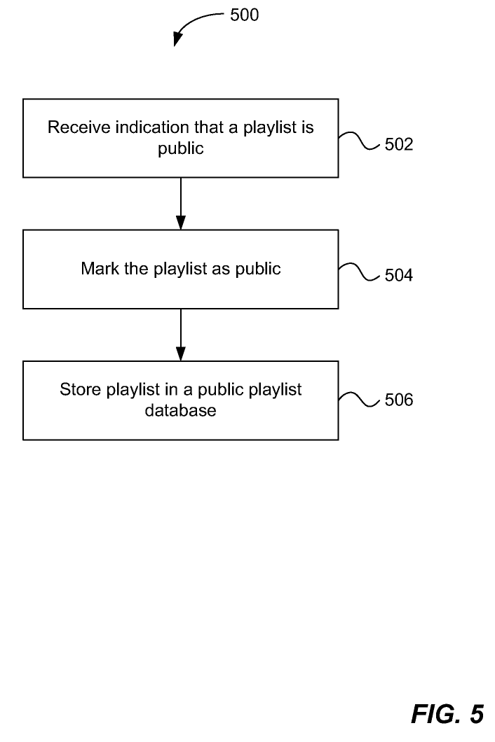

FIG. 5 depicts a flow diagram of a process for marking playlists as public. At process block 502, an indication that a playlist is public is received from a playlist creator. The playlist creator as referenced herein is a user who has created a playlist and has the option of making the playlist public or private. In one embodiment, upon creation of the playlist, the playlist can be created to be private as a default. By option and selection of a user, a playlist can be made public. In one embodiment, a user may choose to publish, i.e., make a playlist public, by clicking on a user interface mechanism such as a button, a link, or a checkbox.

As discussed earlier, playlists can include one or more fields or contents pointers that reference the physical location in memory where the media files reside. Therefore, a public playlist contains pointers that identify a network location, such as a memory location, in which the media file resides and that can be accessed. Therefore, once playlist has been made public, other users accessing content listed in a playlist can be provided access to content through the pointers included in the published playlist. Thus, a user having network access can access media content through the network addresses provided in the playlist. As long as the address of the content is a valid address, the media content can be rendered to the invoking user. Once an indication that a playlist that is public has been received, the process 500 continues to process block 504.

At process block 504, the playlist can be marked as public. In one embodiment, marking the playlist as public simply comprises changing the value of a flag that is associated to the playlist. In another example, making a playlist public comprises making a copy of the playlist in a separate database such as the public playlist database 116. The process 500 continues to process block 506. At process block 506, the playlist is stored in the public playlist database 116.

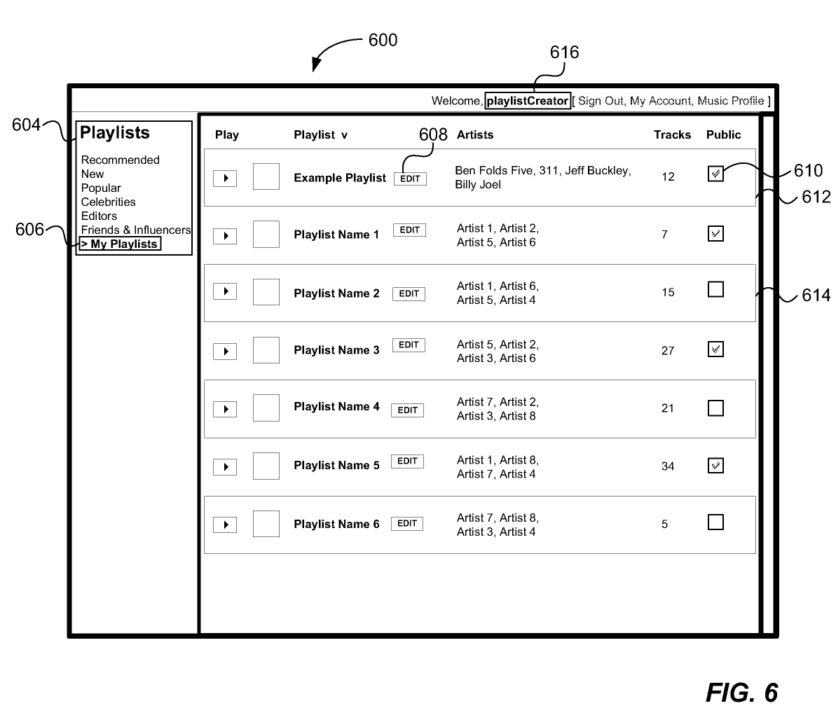

FIG. 6 illustrates a screenshot of a user interface 600 for creating playlists. The user interface 600 can correspond to the interface of a media management program. Examples of media management program include a media player such as the Yahoo! Music Engine. Other media player examples include Windows Media Player, iTunes, Real Media Player, etc. The user interface 600 can display a menu 604 with a set of options. In one embodiment, the playlist menu 604 includes user selectable options such as Recommended playlists, New playlists, Popular playlists, Celebrity's playlists, Editor's playlists, Friends and Influencer's playlists, and My playlists.

A user that has created one or more playlists can view and edit created playlists by selecting the My Playlists option 606. Upon the user selecting the My Playlists option 606, a pane on the right hand side displaying a list of playlists can be provided to the user. The list of playlists can be ordered according to one or more search mechanisms. For example, the playlists can be listed in alphabetical order by the playlist name. In another example, the playlists can be listed according to the number of tracks in ascending order or descending order. Each playlist listed can include information specific to each playlist such that the user viewing the user playlists can have easy access to edit and view the playlists. For example, an entry playlist 612 can include the playlist name “Example Playlist” and an edit button 608 next to the name “Example Playlist”. The edit button 608 can be an edit button that the user selects to edit the user's playlist. Upon selecting the edit button 608 the user can be presented with a user interface for changing playlist information such as artists, the number of tracks in the playlist, the name of the playlist at new media files, etc. In addition, the playlist entry 612 can also include a play button 602. The play button 602 can be provided such that the playlist user can listen to the media or view the media if it is a video, etc. In addition, the playlist entry 612 can also display the number of tracks in the playlist, e.g., twelve. In addition, the playlist entry 612 can further include an indication of whether the playlist is a public playlist or not. If the user wants to designate the playlist as being public, the user can check a checkbox 610 included as part of the playlist entry 612. In another example, instead of a checkbox, the playlist entry can include toggle radio buttons for selecting whether the playlist is public or private. Any other user interface mechanism can also be utilized for a user to indicate whether a playlist is public or private.

Playlist entry 614 shows a check button 618 that has been unchecked and that indicates that the playlist entry 614 is not public. On the other hand, the playlist entry 612 which includes a check on the checkbox 610, has an indication that the playlist is public and therefore that the playlist can be shared with other users. Upon checking the box to be public, the playlist entry 612 corresponding to a specific playlist can be copied to the public playlist database 116 in order to publish the playlist and allow the media management module 112 to access the public playlist database 116 to provide users who are searching for public playlists access to the playlist 612. Furthermore, the playlist recommendation module 108 can also access the public playlist database 116 and recommend published playlists to other users.

In addition, the user interface 600 can further provide an indication 616 displaying a user identifier corresponding to the user creating and editing the playlists. For explanatory purposes, a playlist creator user with user identifier “playlistCreator,” and a second playlist recommendee user having a user identifier “playlistRecommendee” are used herein to describe the differences among the roles of a user who creates a playlist and a user that receives a recommendation of a playlist. It should be apparent to one skilled in the art that all users of the recommendation system as described herein can be both a playlist creator and a playlist recommendee.

In the user interface 600, the user identifier shown by indicator 616 is “playlistCreator”. By way of example, the user playlistCreator is a user that has created Example Playlist shown in entry 612. The Example Playlist can later be recommended to other users according to the playlist recommendation module 108. An exemplary user to whom the Example Playlist can be recommended can be a user with user identifier playlistRecommendee.

Further, in one embodiment, selecting the play 602 button next to each playlist can cause the playlist to be loaded and played by a media management program (e.g., a data media player such as Yahoo! Music Engine or MusicMatch). Through the media management program, a user can manage the user's playlists and associated media content. Playlist management operations are provided by the media management program. For example, a media management program's user interface may allow the user to stop, rewind, fast-forward, pause, and or/stop the playing of the playlist. In another embodiment, the user can copy the playlist and rearrange and/or delete media files to customize the playlist. It is contemplated that users can also be provided with the ability to bookmark other users' playlists, enabling them to keep access to a playlist even as the creator of the playlist makes changes to the playlist.

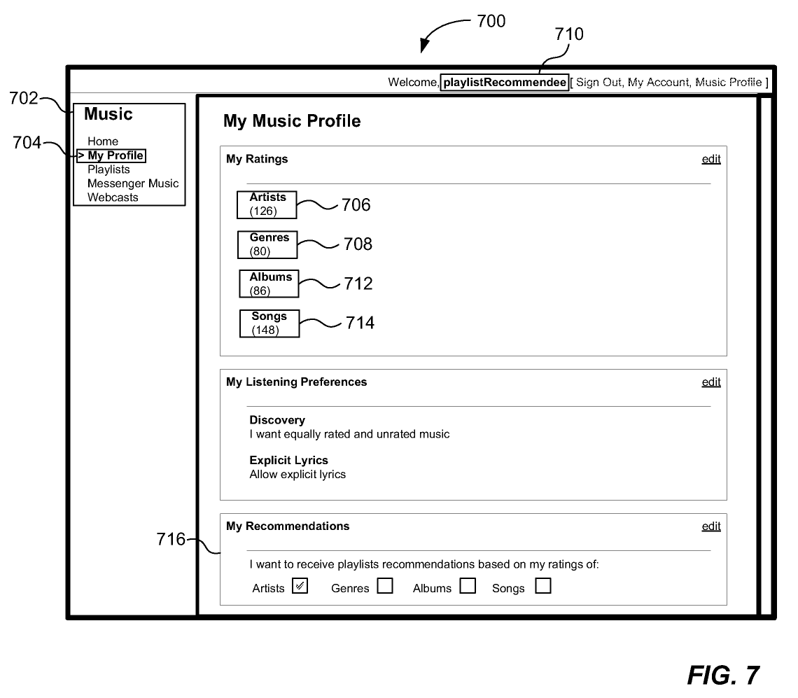

FIG. 7 illustrates a screenshot of a user interface for editing a user profile. The user interface 700 can include a menu 702 for managing music or other media according to the media to a media management program. The menu 702 can include options such as Home, My profile, Playlists, Messenger Music, and Webcasts. Option 704 refers to menu option “My Profile”. Option 704 permits a user to edit the user's profile, set preferences specific to the user and rates media designate listening preferences according to the user's liking.

For example, the user profile can include artist's ratings 706, genre ratings 708, albums ratings 712, and songs ratings 714 as part of the user's profile. The ratings provided by the user can be stored according to a predefined scale, for example, a scale that score one for the lowest rating, and five for the highest rating. As previously explained, the user's profile can be stored in a user profile database 114. In addition, the user interface 700 can include an indicator 710 for displaying the user identifier. As illustrated in user interface 700, the user identifier is “playlistRecommendee”. The playlist recommendation to the playlist recommendee can be based according to logic configured in the playlist recommendation module 108. Recommendations to a playlist recommendee can be made according to playlist recommendee's media preferences. Thus, the preference of the playlist recommendation according to artist entry 706 can be utilized to correlate to public playlists that have similar artists as those indicated in the ratings of the playlist recommendee namely under artist 706. As such, playlist recommendee can be recommended a public playlist having representative artist relevant to the artists that the playlist recommendee user likes.

Other data related to the playlist recommendee and not stored in the playlist recommendee's profile can be utilized to make a recommendation. For example, frequently played artists or songs by the playlist recommendee can be data that is temporarily stored and accessed to make a recommendation to a user.

In one embodiment, playlist representative artist information is relevant to the artist that the recommendee likes if the name of all of the artists that the user likes matches names of the artists in the representative artists. For example, if the playlist recommendee has indicated, under artist ratings 706, that the playlist recommendee enjoys music from artists Jeff Buckley and Billy Joel, the playlist recommendation module 108 can search in the public playlists database for playlists having Jeff Buckley and Billy Joel as representative artists. The Example Playlist discussed in FIG. 2, includes representative artists Ben Folds Five, 311, Jeff Buckley and Billy Joel. Thus, since playlist recommendee has rated the artists Jeff Buckley and Billy Joel with high ratings, it is likely that Example Playlist can be of the liking of the playlist recommendee.

In another embodiment, playlist representative artist information is relevant to the artist that the recommendee likes if the name of some of the artists that the user likes matches names of the artists in the representative artists. For example, if the playlist recommendee has indicated, under artist ratings 706, that the playlist recommendee enjoys music from artists Jeff Buckley, Billy Joel, and Barbara Streisand, the playlist recommendation module 108 can search in the public playlists database playlists having Jeff Buckley, Billy Joel, and Barbara Streisand as representative artists. The Example Playlist discussed in FIG. 2, includes representative artists Ben Folds Five, 311, Jeff Buckley and Billy Joel. Thus, since at least some of the artists that have been highly rated by the recommendee are included in the representative artists, namely Jeff Buckley, Billy Joel, the Example Playlist can be recommended to the recommendee.

In a further embodiment, a user may also be provided with a recommendation preference section 716 to set preferences on how the user wants to receive recommendations. In one example, the recommendation preference section 716 can include checkboxes indicating what user ratings to use in order to generate recommendations for the user. Thus, a user may want to receive playlists recommendations based on the albums that the user has rated. Based on highly rated albums by the user, the user can be provided with recommendations of playlists that include songs that were released in the albums that the user rated.

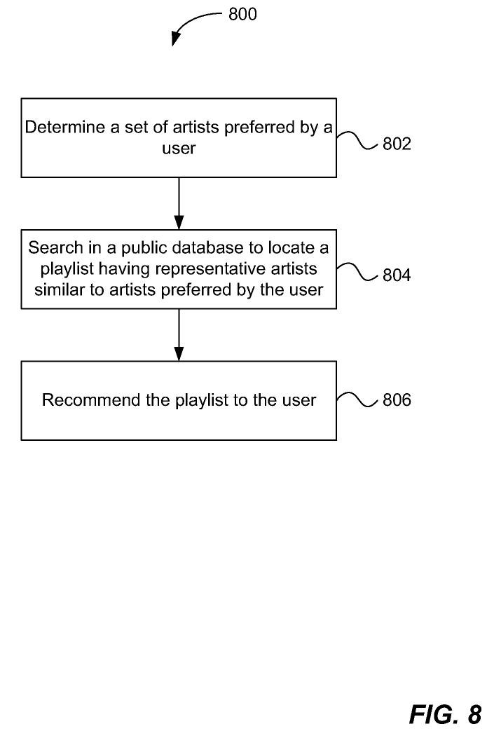

FIG. 8 illustrates a flow diagram of a process of recommending a playlist. At processes block 802 a set of artists preferred by users is determined. A set of artists preferred by users can be determined from the user profile of the user stored at the user profile database 114. In one example, the set of artists can be the first four artists or the top four artists having the highest ratings by the user. In another example, the set of artists can be a set of artists that the user predefines. The user can enter the names of the artists that the user would like to use for playlist recommendation. As such, a user that wants to receive recommendations of playlists having a high number of songs that corresponds to an artist such as Bob Marley, the user can enter in a user interface field the preferred artist Bob Marley. Then, upon determining the set of artists preferred by the user, the system can utilize the predefined artist of Marley set by the user to generate recommendations. The process 800 continues to process block 804.

At process block 804, the public playlist database 116 is searched to locate a playlist having representative artists similar or relevant to the artists preferred by the user. In other words, the public playlist database 116 can be searched for playlists that have high relevancy for the user. Playlist relevancy can be calculated based on one or more algorithms known in the art. In one embodiment, playlists are relevant based on score assigned to the playlists according to the representative artists, songs, and genres of the playlist in comparison with the artists, songs and genres that a user recommendee prefers. Process 800 continues to process block 806.

At process block 806, the playlist located as a result of the search in the public playlist database 116 can be recommended to the user. If the user's preference has not changed, it is likely that the user will consider the recommended playlist.

Furthermore, the method and processes 800 can also be carried out with respect to genres, artists, albums, etc. For example, genre's preferences of a user can be utilized to locate in the public playlist database 116 playlists having similar representative genres.

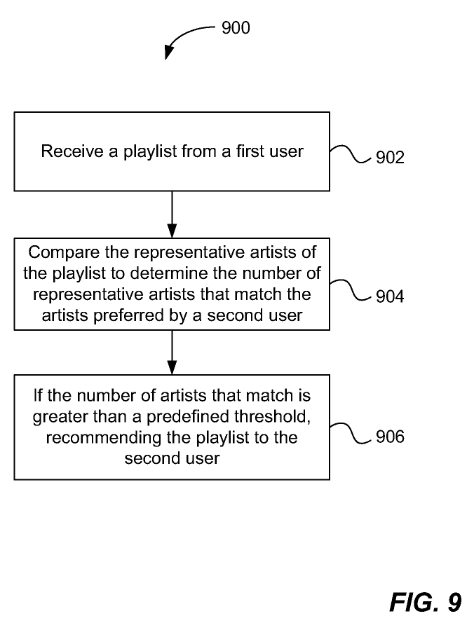

FIG. 9 illustrates a flow diagram of another exemplary process of recommending a playlist. At process block 902, a playlist is received from a first user, such as a playlist creator. The playlist can be received when the playlist is created by the first user and stored at the playlist database 118. In another example, the playlist can be received from a first user when a first user submits the playlist for sharing with other users. Thus, for example, the playlist can be received from the first user when the first user selects or marks the playlist to be a public playlist. The process 900 continues to process block 904.

At process block 904, the representative artists of the playlist are compared with the artists preferred by a second user, e.g. a playlist recommendee to determine the number of representative artists that match the artists preferred by the second user. A representative artist of the playlist can be deemed to match a preferred artist of a second user when the last name of the artist preferred by a second user matches the last name of a representative artist in the playlist. In another embodiment, the representative artist of a playlist can be deemed to match the preferred artist of a second user if the first name and the last name of the artist preferred by the second user match the first name and last name of the representative artist in the playlist. Process 900 continues to process block 906.

At process block 906, if it is determined that the number of artists that match is greater than the predefined threshold. The playlist is recommended to the second user. The recommendation is based on the assumption that the number of representative artists of the playlist that match the artists preferred by the user is a good indicator of the potential interest of the user in the recommended playlist. The predefined threshold of the number of artists that must match can be defined by the second user. Therefore, in one example, the second user can specify that for a playlist to be recommended, at least two artists in a playlist must match the preferred artists of the second user. In another example, the second user can set a predefined number to be three such that at least three artists in a playlist, must match highly rated artists by the second user. In yet another example, the predefined threshold can be set by the playlist recommendation module 108. The playlist recommendation module 108 can set four artists to be the threshold of the minimum number of artists that must match the number of artists that are contained in the playlist that is to be recommended to a user.

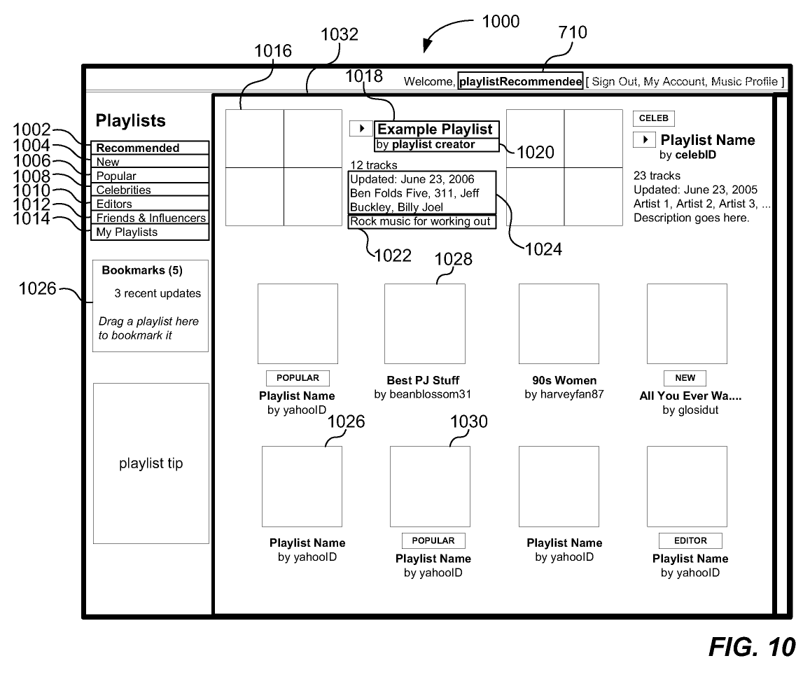

FIG. 10 illustrates a screenshot of a user interface 1000 for recommending playlists. The user interface 1000 can correspond to the interface of a media management program. As previously stated, an example of a user management program can be the Yahoo! Music Engine. The user interface 1000 can be presented to a playlist recommendee who wishes to receive playlist recommendations from the playlist recommendation module 108. The user interface 1000 can include a playlist display pane 1032 wherein user interface components representing playlists can be displayed. For example, thumbnails, buttons, hyperlinks, or other user interface mechanisms can be displayed to provide access to playlists.

The user interface 1000 includes the user indicator 710 that displays the user identifier playlist recommendee. The user interface 1000 further includes a menu for playlists manipulation. A recommended button 1002 can be part of the menu. Other menu items can include a New button 1004, a Popular button 1006, Celebrities button 1008, an Editor's button 1010, a Friend's and Influencer's button 1012 and My Playlists button 1014.

The recommended button 1012 allows a user to access a list of recommended playlists that are populated and are generated according to the methods described previously for recommending playlists to a user. The New button 1004 can permit a user to view new playlists that have been added and the Popular button 1006 can display popular playlists that have acquired a status of popular by virtue of being selected by multiple users. Furthermore, the Celebrity's button 1008 can include the option of displaying playlists that celebrities have created. Similarly, the Editor's button 1010 can include the option of displaying playlists that editors have selected. Likewise, the Friend's and Influencer's button 1012 includes the option of selecting playlists that friends of the user or influencers of the user have created. In one embodiment, the user pre-defines a set of friends and influencers.

In addition, the playlist menu can also include in the My Playlists button 1014 the playlists that have been created by the playlist recommendee. Those playlists, in turn, can later be recommended to other users.

The user interface 1000 can also include a bookmark area 1026. Recommended playlists, such as playlists represented by thumbnails 1026, 1028 and 1030, can be dragged onto the bookmark area 1026.

Featured playlist that have high relevancy or that are featured for other reasons, can be included, on the top of the playlist display pane 1032 and display summarized information, along with a four-picture collage representing the playlist. As such, the four-picture collage can be presented as a thumbnail 1016, that can include, pictures or images or videos of representative artist or albums or other media associated with the playlist. For example, on the top left corner of thumbnail 1016, an image of a first artist or of a representative artist can be displayed. In the top right corner of thumbnail 1016, an image of a second artist representative artist can be included. Likewise, in the bottom left corner of thumbnail 1016, another image of a third representative artist can be included. Finally, on the bottom right corner of thumbnail 1016, an image of a fourth representative artist can be included. Thumbnail 1016 can be displayed with a label 1018 reading the title corresponding to the playlist, illustrated in thumbnail 1006. For example, the title of the playlist can be example: “Example Playlist.”

In addition, the user identifier of the creator of the playlist can also be displayed in conjunction with the label displaying the title of the playlist. For example, a label 1020 can be displayed to read “playlistCreator”, thus displaying the user identifier of the playlist example playlist.

Other information can also be displayed with the playlist recommended to the user. For example, the description of the playlist can be displayed at label 1022. In addition, representative artists related to the playlist can also be displayed in conjunction with other information related to the playlist. Thus, label 1024 can include the name of four representative artist of playlist “Example Playlist.”

In one embodiment, a user can select a recommended playlist by dragging a thumbnail presented to the user into the bookmark area 1026. For example, a user may desire to select thumbnail 1028 associated with the playlist “Best PJ Stuff” and drag the thumbnail to the bookmark's section 1026. Upon the user dragging the thumbnail 1028 into the bookmark's section 1026, a reference or pointer, or link can be included, as a bookmark, in the playlist section. In particular, the bookmark, pointer, or link can be included in the My Playlists section. A user who desires to access the My Playlist section, can access such section by clicking or pressing the My Playlist button 1014.

In another embodiment, a user may select a recommended playlist by double clicking a playlist listed in the recommended playlist section. In yet another embodiment, a user may select a recommended playlist by checking a checkbox, a radio button or any other user interface mechanism that can allow a user to indicate that the user has selected the recommended playlist. The recommended playlists selected by a user can be copied to the section of My Playlist that belongs to a user, such that the complete playlist is contained in the playlist database 118 with reference to the user profile of the playlist recommendee who has selected the playlist. As such, the user can edit or modify the copied playlist and once any edit or modification is made, the new playlist can be renamed by the user or created by the user who just edited the playlist.

Alternatively, once a user selects a playlist, that has been recommended to the user, a bookmark, or link or reference can be established such that a pointer, a file path, or a memory address is stored in relation to the user who selected the playlist. Therefore, the media content and the playlist can reside in association with the creator of the playlist. When the creator of the playlist edits or make changes to the playlist, the recommendee can be benefited from the alterations and improvements made to the playlist.

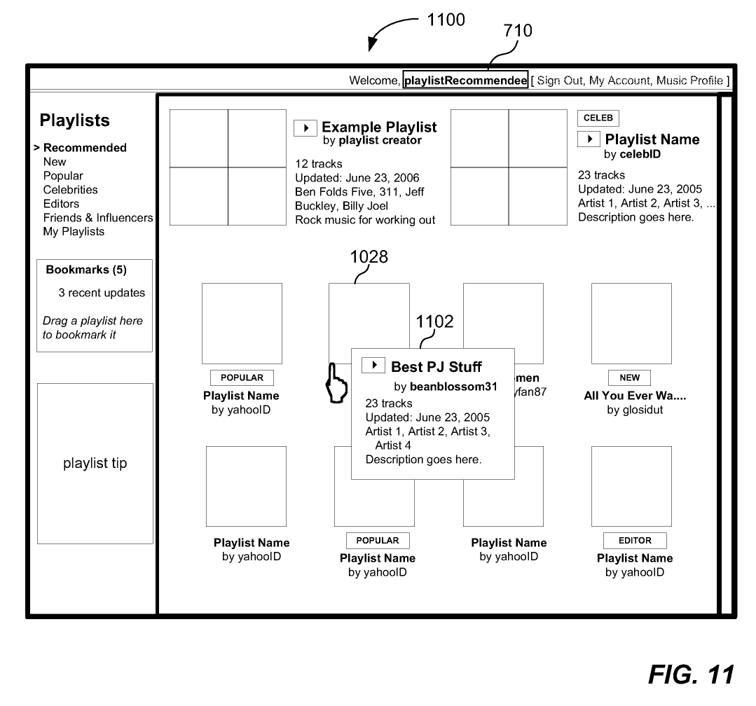

FIG. 11 illustrates a screenshot of a user interface 1100 for recommending playlist to a user. The playlists that are displayed for recommendation to a user can be displayed in the form of thumbnails or a list of playlists. Furthermore, the recommended playlists can be displayed such that upon a user hovering over the thumbnail or another representation of the playlist, a pop-up dialog box 1102 can be displayed. The pop-up dialog box 1102 can further provide recommendation information associated to the recommended playlist to the user. The information displayed in the pop-up dialog box 1102 can include the name of the playlist, the creator's user identifier, the number of tracks, the number of songs, etc.

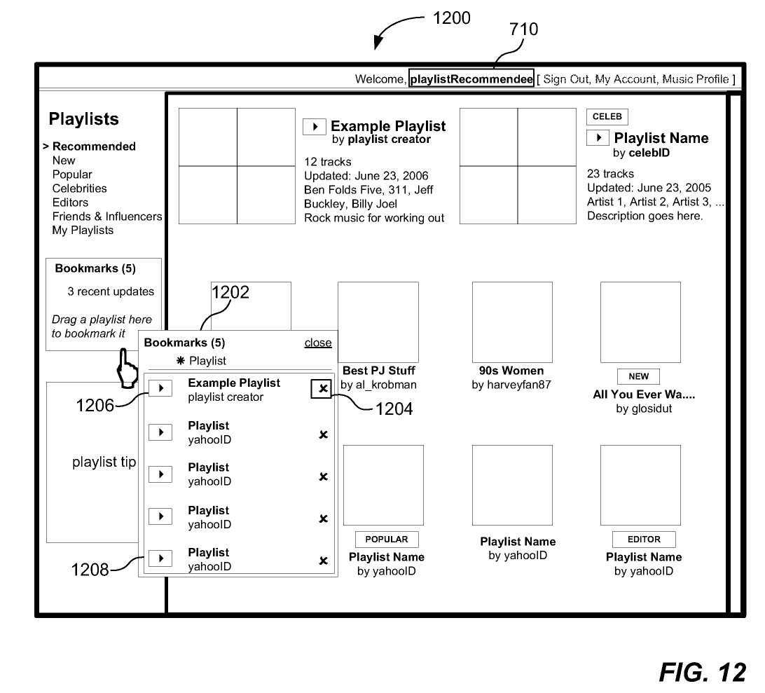

FIG. 12 illustrates a screenshot of a user interface 1200 for recommending playlists. The user interface 1200 can further include an interactive bookmark area 1026, such that, a pop-up dialog box 1202 can be displayed when the user hovers over the bookmark area 1026. The pop-up dialog box 1202 can display a bookmarks list 1208 that lists recommended playlists that have been selected by the user. The bookmarks list 1208 can include the name of each playlist, the playlist creator, a play button, and a delete button. For example, the play button 1206 can be selected by a user to play the media file associated with the first song on the playlist. Once the play button 1206 is selected, the playlist can start playing. The delete button 1204 can be selected to delete the first playlist Example Playlist from bookmarks list 1208.

Providing access of a user's published playlist on a profile page allows users to further get to know other members and browse their musical tastes. Of course, any combination and other areas of information are contemplated. In one embodiment, users can control access to their playlists by making an individual playlist public or private, or by making the entire profile page public or private. Of course, it is contemplated that access to a user's playlist may be controlled by further detailed designations. For example, a user can designated that all playlists are only publicly available to a designated list of friends, other users, or specific online community such as a messenger community.

In one embodiment, the ability to share and view playlists among different users will be dependent on certain Digital Rights Management (DRM). In one embodiment, the playlists created and viewed by another user can contain sufficient DRM information to ensure that the user viewing the playlist has sufficient rights or a specific permission level to permit the user to experience the media contained in the playlist. In one embodiment, this function is controlled by the media management program.

In one embodiment, the ability of a user viewing and/or playing of another user's published playlist to access a media file and/or media file identifier is governed by a permission level. In one embodiment, the permission level may be triggered upon the user attempting to view the playlist. In another embodiment, the permission level may be triggered when the user attempts to play the playlist. Meaning, that in one embodiment, the user can view all playlists, but permission levels can control whether a user can play the media files within the published playlist. Thus, in one embodiment, the ability to view and/or play a media file and/or media file identifier in a published playlist may be governed by a permission level. In one exemplary embodiment, the permission level is associated with the media file. In another exemplary embodiment, the permission level is controlled by a subscription from a service provider. Rights and permissions can be managed by a DRM application or an associated media management application or media player or combination thereof.

In an exemplary embodiment, the permission level depends on each user's status as a subscriber or a non-subscriber to an on-demand-streaming media service (ODSMS). For example, if the user who has published a playlist is a subscriber and the user desiring to view and/or play the published playlist is also a subscriber, then the desiring user can have full access to each ODSMS media file identifier on the playlist. In another exemplary embodiment, if the user publishing the playlist is a subscriber to an ODSMS and the user desiring to view and/or play the published playlist is a non-subscriber, then the desiring user may have limited access to the ODSMS media files. For example, the desiring user may be limited to a pre-determined length clip of each ODSMS media file, such as a 30-second clip when the desiring user plays the media file. In another example, the desiring user may be given a pre-determined number of times the user can play each ODSMS media file. After this pre-determined number of times has been reached, the user is then limited to a default, pre-determined length of time for each media file (such as a thirty-second clip). For example, the user may be limited to playing an ODSMS media file at its full-length to three times. Thus, once the user had played the media file and/or media file identifier three times, the user can now only listen to thirty-second clips of the media file. This allows a non-subscribing desiring user to listen to ODSMS music otherwise not available to the user, while enticing the user to subscribe to the service. Accordingly, in one embodiment, once the user's pre-determined numbers of full-length plays are used, the user is prompted and has the option to subscribe to the ODSMS.

Of course, these embodiments are not limited to ODSMS media files, but can apply to any media files that require a specified level of sharing, viewing, and/or playing access. For example, it could be negotiated that certain media files generally not available for full-length sharing could be shared and played between any user for a pre-determined number of times. For example, if there is a particular artist who wants to promote and/or entice users to listen to their media files, the artist or their representatives can allow a particular media file to be able to be viewed and/or played among any type of users. However, the users are limited to playing the media file to a certain number of times.

In another embodiment, the user can further utilize the collaborative playlist by burning the playlist to a CD or transferring the media files to a portable device. For example, the user can burn the media filed listed in playlist in the media player window to a CD and/or transfer the media files to a portable device by clicking a button and selecting the option from a drop-down menu. In some embodiments, the ability to transfer media files to a portable device or burn media files to a CD may depend on whether the user has specified access to those media files. Particularly, the user may be required to pay for files not located on the user's local media library. For example, the user may be required to pay for files located on an on-demand, streaming media service. Thus, the user may be required to pay a price for each media file before downloading or burning the media files. In another example, the user may be required to be subscriber to a service that allows the user to download and burn media files. In a further embodiment, the user can perform any of the above managing functions in any combination as the user desires using the media management program.

Playlists are not limited to music files and can include other audio or video files. For example, this system could be used to build playlists of music videos or to develop playable lists of music, audio news, commentary, RSS feeds, podcasts, still images, and video content.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

1. A method of recommending playlists to a user, comprising:
identifying a set of artist names corresponding to artists that the user has indicated a preference for;
accessing a playlist repository that stores media playlists which include artist information;
searching the playlist repository to identify a playlist having playlist artist information that is relevant to the user-identified set of artist names; and
communicating the identity of the identified playlist to the user.

2. The method of claim 1, further comprising receiving a selection of the playlist by the user.

3. The method of claim 2, further comprising storing a bookmark that references the playlist for later access by the user.

4. The method of claim 2, further comprising storing a copy of the playlist later access by the user.

5. The method of claim 4, further comprising permitting the user to edit the copy of the playlist.

6. The method of claim 1, further comprising communicating the identity of at least one popular playlist to the user.

7. The method of claim 1, further comprising communicating the identity of at least one celebrity selected playlist to the user.

8. The method of claim 1, wherein a preference indication is derived from a playlist created by the user.

9. The method of claim 1, wherein the set of artist names correspond to representative artists of a playlist created by the user.

10. The method of claim 1, wherein the set of artists names are obtained from a user profile stored in a user profile database.

11. The method of claim 1, wherein the artist information corresponds to artists that are representative of the artists in the playlist.

12. The method of claim 1, wherein the playlist repository comprises a public playlist database containing data related to published playlists.

13. The method of claim 1, further comprising receiving from the user an indication of preference of an artist by receiving a rating of the artists based on a predefined scale.

14. The method of claim 1, further comprising storing in the playlist repository a system generated playlist.

15. The method of claim 1, further comprising storing in the playlist repository a user created playlist, the user created playlist being created by a playlist creator.

16. The method of claim 1, wherein the playlist comprises a playlist of video clips.

17. The method of claim 1, wherein the playlist comprises a playlist of songs.

18. The method of claim 1, wherein the artist information is indicative of representative artists of the playlist.

19. The method of claim 1, wherein a representative artist of the playlist is an artist that is associated with at least two songs in the playlist.

20. The method of claim 1, wherein a representative artist of the playlist is an artist that is associated with at least three songs in the playlist.

21. The method of claim 1, wherein artist information is relevant to the set of artist names if all of the names of the set of artist names match the artist information of the playlist.

22. The method of claim 1, wherein artist information is relevant to the set of artist names if some of the names of the set of artist names match the artist information of the playlist.

23. A system for recommending playlists to a user, comprising:
a playlist repository that stores media playlists which include artist information; and
a recommendation module that searches the playlist repository to identify a playlist having artist information that is relevant to a set of artist names, the set of artist names being indicative of the artists for which the user has indicated a preference, wherein the recommendation module is further configured to communicate the identity of the identified playlist to the user.

24. The system of claim 23, further comprising a user profile database that stores a user profile corresponding to the user, wherein the user profile stores the set of artists names.

25. The system of claim 23, wherein the artist information corresponds to artists that are representative of the artists in the playlist.

26. The system of claim 23, wherein the playlist repository comprises a public playlist database containing data related to published playlists.

27. The system of claim 23, wherein the user indicates a preference for an artist named in the set of artist names by rating the artist with a high score.

28. The system of claim 23, further comprising a media management module that generates playlists.

29. The system of claim 23, wherein the playlist repository is configured to store user created playlists, the user created playlist being created by a playlist creator.

30. The system of claim 23, wherein the playlist comprises a playlist of video clips.

31. The system of claim 23, wherein the playlist comprises a playlist of songs.

32. The system of claim 23, wherein the artist information is indicative of representative artists of the playlist.

33. The system of claim 32, wherein a representative artist of the playlist is an artist that is associated with at least two songs in the playlist.

34. The system of claim 32, wherein a representative artist of the playlist is an artist that is associated with at least three songs in the playlist.

35. A method of recommending playlists, comprising:
identifying media preferences corresponding to characteristics of media that a user has indicated a preference for;
accessing a playlist repository that stores media playlists, wherein at least one playlist in the playlist repository comprises associated media information;
searching the playlist storage to identify a playlist with information relevant to media preferences of the user; and
communicating the identity of the relevant playlist to the user.

36. The method of claim 35, wherein the media preferences are stored in a user profile database.

37. The method of claim 35, wherein the media preferences of a user are identified utilizing media ratings from a user profile stored in a user profile database.

38. The method of claim 35, wherein media preferences can include one or more artists preferred by a user.

39. The method of claim 35, wherein media preferences can include one or more genres preferred by a user.

40. The method of claim 35, wherein the playlist comprises a playlist of video clips.

41. The method of claim 35, wherein the playlist comprises a playlist of songs.

42. A user interface for recommending playlists, comprising:
a playlist display pane that includes at least one thumbnail representing a playlist, wherein the at least one thumbnail includes one or more images representative of playlist information; and
a bookmark area to which the at least one thumbnail can be dragged onto, wherein upon the at least one thumbnail being dragged onto the bookmark area, the playlist being represented by the at least one thumbnail is selected by the user.

43. The user interface of claim 42, wherein the images correspond to artists of the playlist.

44. The user interface of claim 42, wherein the images correspond to albums related to the playlist.

45. The user interface of claim 42, wherein upon selection of the playlist by the user the playlist is added to a list of playlists.

46. The user interface of claim 45, wherein upon hovering over the bookmark area, the list of playlists can be displayed in a pop-up dialog box.

47. The user interface of claim 46, wherein the pop-up dialog box can further include a play button next to each playlist in the displayed list of playlists.

48. The user interface of claim 42, wherein upon hovering over the at least one thumbnail, information related to the playlist can be displayed in a pop-up dialog box.
